(19) United States
(12) Patent Application Publication
(10) Pub. No.: US 2009/0174219 A1
(43) Pub. Date: Jul. 9, 2009

(54) VEHICLE ENERGY ABSORBER STRUCTURE AND METHOD

(76) Inventor: Grant G. Foreman, Bellefontaine, OH (US)

Correspondence Address: CERMAK KENEALY VAIDYA & NAKAJIMA LLP, 515 EAST BRADDOCK RD SUITE B, Alexandria, VA, 22314, US

(21) Appl. No.: 12/341,530

(22) Filed: Dec. 22, 2008

Related U.S. Application Data
(60) Provisional application No. 61/018,893, filed on Jan. 4, 2008.

(51) Int. Cl. B62D 21/15

(52) U.S. Cl. 296/187.03

(57) ABSTRACT

An energy absorber structure and method for use in a vehicle includes providing an extrudable tubular structure that can be easily varied in thickness and width dimensions to be tuned for particular vehicle energy absorbing applications. The variable extrusion can provide a tubular structure that has walls having differing or variable thicknesses, as well as differing or variable height and width dimensions. The simplicity of the variable extrusion allows for the use of cheap materials, quick prototype turn around tuning times, and more efficient design for the energy absorber structure placed in a particular vehicle or a particular application in a vehicle.

This application claims the priority benefit under 35 U.S.C. §119 of U.S. Provisional Patent Application No. 61/018,893 filed on Jan. 4, 2008, which is hereby incorporated in its entirety by reference.

### BACKGROUND

1. Field

The presently disclosed subject matter relates to an energy absorbing structure and method for manufacture as well as method for use in relieving impact forces for a vehicle and for dampening vibrations in a vehicle chassis or body.

2. Description of the Related Art

In recent years, manufacturers have started adding energy absorbing members, or energy absorbers, to vehicles. Energy absorbers are typically positioned between a structural member of the vehicle body and one or more interior trim pieces. For example, an energy absorber may be positioned between the B-pillar and an interior trim piece covering the B-pillar. Other structural members where energy absorbers are typically installed include the A-pillar, the roof rail, the bumpers, and other similar structures.

During a collision involving a vehicle, occupants may move from their initial position with respect to the vehicle and impact one or more interior portions such as a door trim panel, an A-pillar cover, a B-pillar cover, etc. If one or more energy absorbers are positioned between the interior trim pieces and structural members of the vehicle, the energy absorbers can absorb at least some of the energy and prevent the energy from being transmitted to the occupants.

There are, however, several disadvantages with known energy absorbers. For example, honeycomb structures produced from either paper (e.g., kraft, NOMEX.R™. etc.), aluminum, or plastic have been used as energy absorbers. However, the potential for moisture absorption makes paper honeycomb undesirable for long life applications. Aluminum honeycomb is expensive to manufacture, and is also subject to corrosion and conductivity of heat and electricity. Plastic honeycomb is both difficult and expensive to manufacture. Furthermore, honeycomb structures typically only perform well in a single impact direction. If the honeycomb is struck off-axis, its effectiveness may be reduced.

There are cost and design issues associated with attaching known energy absorbers to vehicle interior portions. It is desirable to provide an energy absorber that will conform to the shape of various vehicle portions, including seat belt mechanisms, hangar devices, lighting accessories, side curtain air bags, etc. Therefore, different energy absorbers are typically designed for different types of vehicles.

Accordingly, it would be an advancement in the art to provide an energy absorber which can be fabricated relatively easily at a lower cost than existing energy absorbers, and which can be easily tuned for specific vehicle applications. Namely, it would be helpful if a completely new mold design is not necessary to produce each iteration or prototype of the energy absorber to determine its optimal use with a particular vehicle or a particular application.

Two common energy absorbers in use are plastic molded rib structures and composite tubular materials. The plastic molded rib structures are inexpensive if used in high quantity, but tooling costs are relatively high and therefore tuning of such an energy absorber for a particular application is difficult. In addition, if a problem is encountered after manufacture of a vehicle begins, the retooling costs to fix the problem are high and can wipe out any expected cost savings. With regard to the composite tubular materials, the cost of the material itself is relatively high.

Another specific example of a known energy absorber includes those energy absorbers formed by an extrusion process and which include creases extending perpendicularly with respect to the longitudinal axis of the extruded part. The creases in the energy absorber make it easier to bend, thus simplifying the process of fitting the energy absorber around curved portions of a vehicle's interior. The creases can be formed in the energy absorber by calendering. In particular, a plurality of wheels may be provided adjacent to the exit of an extrusion die. As the extrusion exits the extrusion die, the wheels are configured to form the creases in the energy absorber by continuously pressing and then releasing over a period of time.

Another type of energy absorber suitable for the interior of a vehicle is known as a blow molded head impact criterion (HIC) formation with energy buffers. This structure is a continuous sheet of material with a plurality of foam ridge line type protrusions molded across and entire width or length of the sheet. The blow molded structure can be formed as a large flat sheet for placement in various panels in the interior of the vehicle. The absorber is intended to dampen automobile occupant head impact energy within a collapsing section of the automobile.

Another type of energy absorber includes large tubular structures that are designed to fit into various portions of the vehicle, such as pillars, etc., to diminish impact and absorb impact energy. This tube type of energy absorber dampens the transmission of energy from an external force applied to a vehicle body with little or no resultant increase in weight of the vehicle. The energy absorber is made of a composite in which kraft paper is placed on the outside and inside of a metal sheet such as iron foil or hard aluminum foil.

Yet another type of energy absorber is an impact energy absorber configured as a flexible pipe or tube having a substantially quadrangular cross section and provided with spiral-shaped concaves and convexes on the outside and inside of hard aluminum foil. The impact energy absorber is bonded to the room-side surface of an outer panel of the vehicle body using an adhesive. When an external force is applied to the impact energy absorber, energy resulting from the external force can be absorbed by plastic deformation of the impact energy absorber. This type of energy absorber can also be incorporated into the vehicle design as air ducts and other components to provide dual purpose structures.

Finally, it is also known to simply include a foam material between an interior trim portion and a structural component of the vehicle such as the A-pillar, etc. The foam can be a polypropylene foam, urethane foam or other known foam.

### SUMMARY

According to one aspect of the disclosure, a method for tuning an energy absorber for use on a vehicle can include providing a die including a set of die parts, providing an extrudable material, and using the set of die parts to extrude the extrudable material into an initial part having a tubular shape. The initial part can have a variety of shapes, including an initial polygonal cross section shape as viewed along a longitudinal axis of the initial part. At least a first wall of the polygonal section shape can have an initial part first wall thickness t1 and width x. The method can include re-using only the previously used die parts to extrude the extrudable material into a following part having a tubular shape. The following part can have a substantially same polygonal or other cross section shape as the initial polygonal section, and a first wall of the cross section shape can have a following part first wall thickness t1 and width x. Finally, the method can also include determining at least one of an optimum thickness for t1 and optimum width for x by comparing a corresponding one of the initial part first wall thickness t1 and width x with a corresponding one of the following part first wall thickness t1 and width x, and producing an energy absorber having a polygonal cross section shape and a first wall having at least one of the optimum thickness t1 and optimum width x. The extrudable material can be a plastic material, and possibly a polypropylene material. The set of die parts can consist or consist essentially of a die body, at least one protrusion structure, and at least one die plate.

According to another aspect of the disclosed subject matter, a method for making an energy absorber for a vehicle can include using a set of die parts to extrude a first energy absorber having a first wall, and the first wall having a first thickness and first width, using the same set of die parts to extrude a second energy absorber having a first wall, and the first wall of the second energy absorber has a second thickness and a second width, and at least one of the second thickness and second width is different from a respective one of the first thickness and first width of the first energy absorber. The method can include determining whether to mass produce the first energy absorber or the second energy absorber, and mass producing at least one of the first energy absorber and the second energy absorber. The first energy absorber can also include a second wall, and the second wall can have a thickness and a width. The second energy absorber can also include a second wall, and the second wall of the second energy absorber can have a thickness and a width, and at least one of the thickness and width of the second wall of the second energy absorber can be different from a respective one of the thickness and width of the second wall of the first energy absorber. In addition, the energy absorber can have a variety of cross sectional shapes when viewed along the longitudinal axis of the energy absorber, including square, rectangular, circular, oval, polygonal, and other symmetrical or non-symmetrical shapes.

According to another aspect of the disclosed subject matter, an energy absorber for use in a vehicle can be made by a process including extruding an initial tubular structure having a first wall having a first wall thickness, extruding a second or following tubular structure having a first wall, and the first wall of the following tubular structure having a wall thickness that is different from the initial tubular structure first wall thickness, using the same set of die parts to extrude the following tubular structure, determining an optimal first wall thickness based on characteristics of the initial tubular structure and the following tubular structure, and extruding a final tubular structure to form the energy absorber.

In accordance with another aspect of the disclosed subject matter, a vehicle energy absorber system, can include a vehicle support structure, a vehicle interior structure, and an energy absorber located between the vehicle support structure and the vehicle interior structure. The energy absorber can include a top wall located adjacent the vehicle interior structure, a bottom wall located adjacent and closer to the vehicle support structure than the top wall, the top wall and the bottom wall extending substantially parallel with respect to each other, a first curved side wall extending continuously between and connecting the top wall and bottom wall with a concave surface exposed to an exterior of the energy absorber, and a second curved side wall extending continuously between and connecting the top wall and bottom wall with a concave surface exposed to an exterior of the energy absorber.

### BRIEF DESCRIPTION OF THE DRAWINGS

The disclosed subject matter of the present application will now be described in more detail with reference to exemplary embodiments of the apparatus, given by way of example, and with reference to the accompanying drawings, in which:

FIG. 1 is a schematic view of a possible configuration for an energy absorber relative to other vehicle structures;

FIG. 2 is a graph showing target performance for an energy absorber plotting deceleration versus time for a test head form impact;

FIG. 3 is a graph showing target performance for an energy absorber plotting force versus distance for a test head form impact;

FIG. 4 is a perspective view of an exemplary embodiment of an energy absorber made in accordance with principles of the disclosed subject matter;

FIG. 5 is a front schematic view of a die made in accordance with principles of the disclosed subject matter;

FIG. 6 is a perspective cross-sectional view of another exemplary embodiment of an energy absorber made in accordance with principles of the disclosed subject matter;

FIG. 7 is a schematic view of the energy absorber of FIG. 6 attached to a vehicle;

FIG. 8 is a flow chart depicting a process in accordance with principles of the disclosed subject matter.

### DETAILED DESCRIPTION OF EXEMPLARY EMBODIMENTS

Components of the exemplary embodiments described below could be arranged and designed in a wide variety of different and interchangeable configurations. Thus, the following more detailed description of certain exemplary embodiments of the disclosed subject matter is not intended to limit the scope of the invention, as claimed, but is merely representative of certain embodiments of the disclosed subject matter.

Vehicles include a number of structural members that provide support for various components of the vehicle. The structural members can include an A-pillar, a B-pillar, and a roof rail which connects the A-pillar and the B-pillar, as well as other structures. The various structural members of the vehicle are typically covered by decorative trim pieces, such as an upper trim piece or roof liner, escutcheons, covers, seat belt mechanism covers, etc.

During a collision involving the vehicle, an object (e.g., a stationary object, moving object, another vehicle, etc.) may strike or be struck by the vehicle. Some or all of the energy of the object may be transferred to one or more structural members of the vehicle. For example, in a side impact collision, an object may strike the side of the vehicle at the location of the B-pillar. The energy of the object may be transferred to the B-pillar, causing it to collapse inward. This chain of events may cause one or more interior trim portions to strike an occupant of the vehicle. Alternatively, an occupant may be moved during an impact and caused to contact an interior trim portion.

One way to absorb impact energy from occupants striking or being struck by interior trim pieces in a vehicle is to attach an energy absorber to one or more of the structural members or trim portions of the vehicle. For example, an energy absorber may be attached and run along the length of the B-pillar. When the B-pillar is struck and begins to collapse inward, the energy absorber may absorb some of the energy transmitting through the collapsing B-pillar. The energy absorber may therefore dissipate impact energy that would otherwise be transferred to vehicle occupants when contacted with the interior trim pieces. Moreover, the energy absorber may reduce energy that would otherwise be transferred to an occupant of the vehicle during a collision. Likewise, an energy absorber can absorb kinetic and other energy from a moving occupant of the vehicle and dissipate that energy before the occupant arrives at the structural component of the vehicle, such as the B-pillar. The energy absorber is key to meeting certain vehicle test requirements and therefore it is helpful if the absorber is “tunable” to compliment other parts of the vehicle to achieve desirable test results. In other words, it is helpful if rapid and cheap prototyping of the energy absorber can take place to ensure the most efficient and effective energy absorber is placed in the vehicle and that the test criteria are easily achieved. The other parts of the vehicle that compliment the energy absorber to provide test results within certain criteria can include the vehicle body, the pillar garnishes, the side curtain air bags, the rooflining, and other similar vehicle parts. Of course, the amount or size of the energy absorber can also be changed to meet certain test criteria.

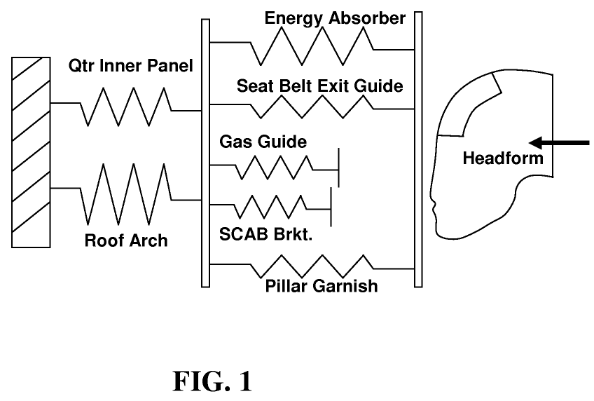

Referring to FIG. 1, each impact point within a vehicle (e.g., the roof arch, the quarter inner panel, etc.) has a unique stiffness and subsequently can have an exclusively designed energy absorber. The force displacement characteristics of the desired energy absorber are dependent upon interaction with other components of the vehicle interior such as grab handles, pillar garnishes, gas guides, side curtain airbag (SCAB) modules, seat belt exit guides, etc. The energy absorber is the variable in this equation and, as indicated above, can be designed to complement the other parts of the vehicle interior. The disclosed extrusion tuning technique for the energy absorber allows for this complimentary design feature at a low cost and short lead time.

By varying tuning variables, including the wall thickness, part height, part geometry, corner radii, and material properties, an infinite library of energy absorber performance characteristics and profiles can be achieved. The disclosed subject matter provides the capability to change the performance of the energy absorber, not only by amplitude with part thickness, but also the fracture and crush mode complimenting other interior components stiffness. This maximizes the efficiency of the design. The disclosed extrusion process lends itself to allow for quick and inexpensive adjustments to the stiffness of the part.

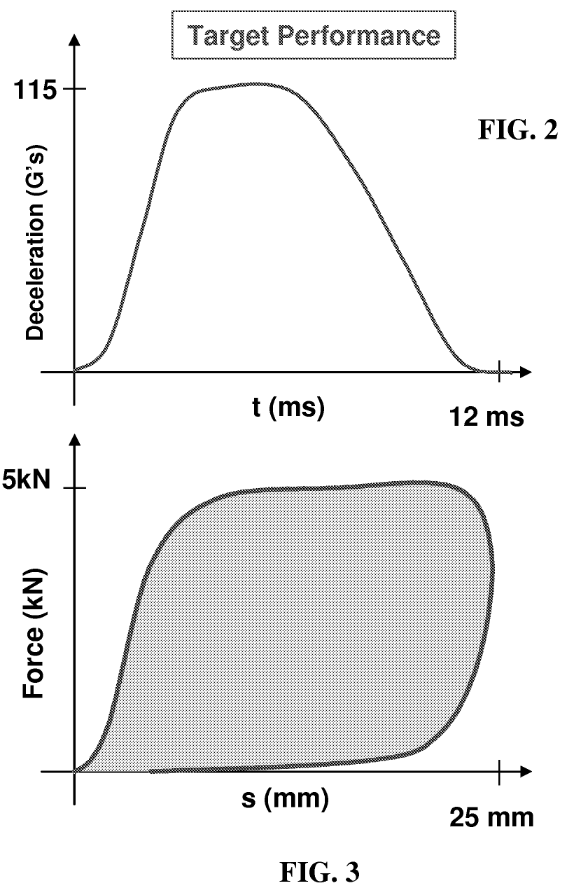

Exemplary performance curves for an energy absorber are shown in FIGS. 2 and 3. A particular energy absorber can be designed to fall within the target performance shown within these test data curves. Specifically, FIG. 2 is a graph showing deceleration versus time for a known impact on a vehicle by a test object (e.g., head form). Similarly, FIG. 3 is a graph showing force versus distance for a known impact on a vehicle by a head form.

The disclosed extrusion process for an energy absorber allows for quick modification to the performance of the part to account for design changes to other components throughout the development process.

The height of the energy absorber extrusion part can be determined or defined by the vehicle body stiffness at the impact location. Once this height is fixed, the stiffness of the part can be determined or defined by varying the aforementioned tuning variables. The additional components contacted by the head form can be estimated for their stiffness, and the role of the energy absorber is the fill gap to achieve an optimum performance curve to maximize interior volume and visibility while providing a safe interior for the occupant in the event of an impact. The extrusion part flexibility for the disclosed energy absorber and process is the vehicle that allows this optimization to occur under the confines of a short development cycle and at a low cost.

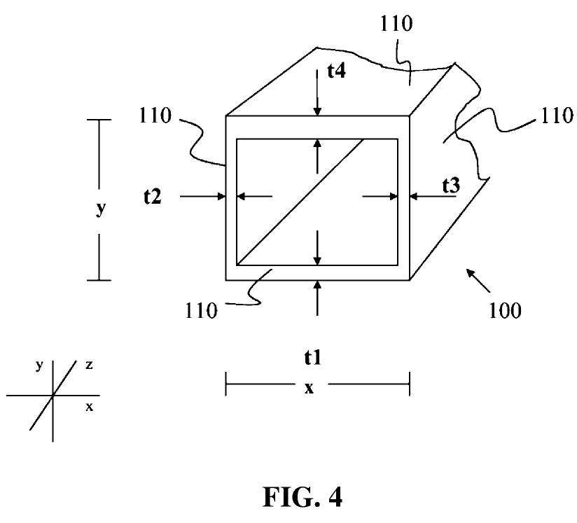

FIG. 4 shows a perspective view of an example of an energy absorber 100 made in accordance with principles of the disclosed subject matter. In this embodiment, the energy absorber 100 is tubular in shape and has a substantially square cross-section. The energy absorber 100 extends in a tubular fashion along a longitudinal axis (parallel to the z-direction shown in FIG. 4). As shown, the energy absorber 100 includes an interior hollow portion. Although the embodiment shown is substantially square in cross section when viewed along a longitudinal axis of the energy absorber, the cross-sectional shape can also include rectangular, circular, oval, polygonal, and other symmetrical or non-symmetrical shapes. In addition, although a single tube is shown, the energy absorber can be comprised of a plurality of tubes that are simultaneously molded or that can be later attached together.

A first outer contact surface of the energy absorber 100 may be configured to be attached to a structural member of the vehicle, such as the B-pillar. For example, two holes may extend through the first contact surface, the interior portion, and the second contact surface. Any suitable attachment mechanism may be inserted through the holes and into corresponding holes in the B-pillar to attach the first contact surface to the B-pillar. For example, a pair of threaded bolts, rivets, clamps, clips, etc., may be used. In one embodiment, the attachment structures may have a larger diameter than the holes, and be held in place by resistance. Of course, in alternative embodiments, the energy absorber 100 may be attached to any structural member of the vehicle using any number of known attachment mechanisms. In addition, holes need not be used. Instead, the energy absorber 100 could be attached to a vehicle structural member by adhesive, welding, etc. In addition, a separate clamp or other attachment structure such as a wire or clip can be provided that attaches about or to an exterior portion of the energy absorber 100 to attach it to any structural member of the vehicle.

The exemplary energy absorber 100 shown in FIG. 4 includes a plurality of side walls 110. Each of the side walls 110 can be formed of a different, similar, or exactly same thickness t1, t2, t3, and t4. Each of the thicknesses can be determined in order to provide several functional qualities. Specifically, the combination of thicknesses t1-t4 can be selected in order to “tune” the energy absorber for a particular application or vehicle. If a certain energy absorption characteristic or quality is required/desired, the thicknesses t1-t4 can be selected to meet such criteria. In addition, the simple and specific configuration of the energy absorber 100 allows each of the thicknesses t1-t4 to be easily varied and prototyped to easily tune the product.

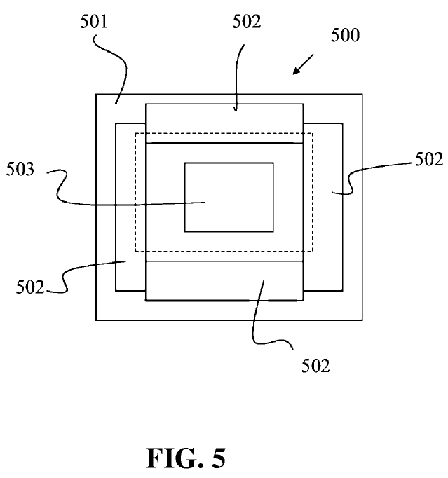

As shown in FIG. 5, the energy absorber 100 may be formed by conveying an extrudable material through an extrusion die 500. The extrusion die may include a die body 501 and several die plates 502. Each of the plates 502 can be moved relative to the die body 501 to separately and distinctly vary each of the thicknesses t1-t4 of the energy absorber 100. The die body 50l may include a support portion and a shaping portion, and the support portion can include an entrance cavity. The die body 501 may also include an exit cavity which matches the exterior shape of the energy absorber 100 to be extruded. At least one protrusion 503 can be formed in the support portion and extend through the shaping portion and into or past the die plate(s) to form the interior portion shape of the energy absorber 100 when it is extruded. The protrusion(s) 503 and/or die plate(s) 502 can be moved relative to the die body 501 to increase or decrease the wall thicknesses t1-t4 of the energy absorber 100 and/or to increase and/or decrease the entire width dimension x or height dimension y. It should be noted that the width x and height y can be interchangeable, and that one can be greater than the other for various shapes, or vice versa for the same shape. In addition, differing protrusions 503 and die plates 502 can be provided to provide different shaped extrusions. For example, a larger protrusion 503 can be provided to create a larger throughhole and relatively thinner walls in the extruded body.

An extrudable material suitably heated to its molten state may enter through an entrance cavity in the die. The molten extrudable material may then flow into the shaping portion, where it may be extruded past the die plate(s) 502 and protrusion(s) 503 and into the desired form of the energy absorber 100. During this process, cooling may occur so that the energy absorber 100 may maintain its shape upon leaving the die. These and other additional details about the extrusion die and the extrusion process generally are readily apparent to those of ordinary skill in the art.

The process for making the energy absorber 100 and the design of the energy absorber 100 itself allows the energy absorber 100 to be produced in a relatively inexpensive manner. In addition, as will be described in more detail below with respect to the process for manufacturing or tuning the energy absorber 100, the design and process for manufacturing the energy absorber 100 allows for efficient production and/or prototyping, and provides the ability to easily tune the absorber 100 for a particular application or vehicle by quickly and efficiently changing the thickness dimensions t1-t4 and/or the width and height x, y dimensions or shapes. Each of these dimensions has an effect on the ability of the energy absorber 100 to absorb specific types of impact energy and to conform to particular vehicle spaces. In particular, certain shapes for the energy absorber 100 allow better energy absorption at a larger range of angular impacts, while other shapes provide higher energy absorption at a specific angular impact.

The energy absorber 100 may be configured to conform to the shape of a structural member and/or mating vehicle component to which it is attached. One way in which this may be accomplished is by manufacturing the energy absorber 100 using an extrudable, flexible material such as known plastics (e.g., crystalline resin, polypropylene resin, polyvinyl chloride resin), or the like. If an extrudable, flexible material is used, the energy absorber 100 may more readily conform to the shape of a structural member. However, other types of extrudable, more or less flexible material can be used.

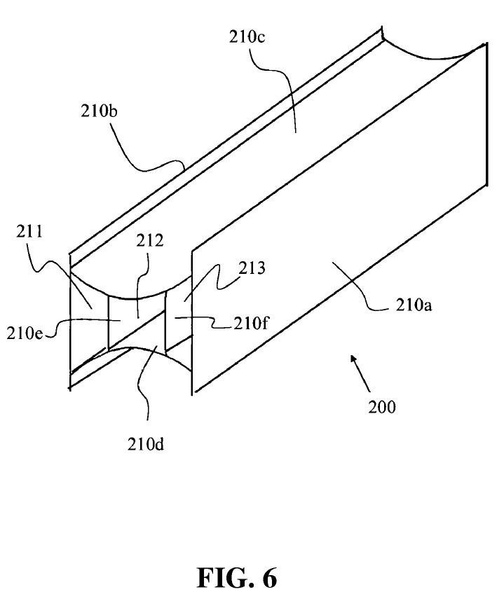

FIG. 6 shows a perspective cross-section of another exemplary embodiment of an energy absorber 200 made in accordance with principles of the disclosed subject matter. In this case, the energy absorber 200 includes a top wall 210a , a bottom wall 210b , a first side wall 210c , a second side wall 210d , a first inner wall 210e and a second inner wall 210f. The top wall 210a and bottom wall 210b are larger than the side walls 210(b, c) and inner walls 210(d, e) and extend substantially parallel with respect to each other. Side wall 210c is spaced slightly inward from an upper edge of both the top wall 210a and bottom wall 210b , and is curved such that a concave surface is exposed exterior to the absorber 200. Likewise, side wall 210d is spaced slightly inward from a lower edge of both the top wall 210a and bottom wall 210b , and is curved such that a concave surface is exposed exterior to the absorber 200. The resulting structure appears similar to an “I-beam” that includes an opening running through and along the length of the beam. Two inner walls 210e and 210f are located within this opening defined by the walls 210(a, b, c, d), and run substantially parallel with the top wall 210a and bottom wall 210b . Thus, the interior cavity of the “I-beam” like structure is separated into three cavities, 211, 212, and 213. Outer cavities 211 and 213 can be mirror images of each other and can each be formed in a substantially trapezoidal shape in a cross-section taken normal to a longitudinal axis of the absorber 200. The center cavity 212 separates the outer cavities 211 and 213 and can be a substantially square or rectangular shaped cavity in a cross-section taken normal to the longitudinal axis of the absorber 200. Two sides of the substantially square or rectangle shaped cavities are curved, as shown in FIG. 6.

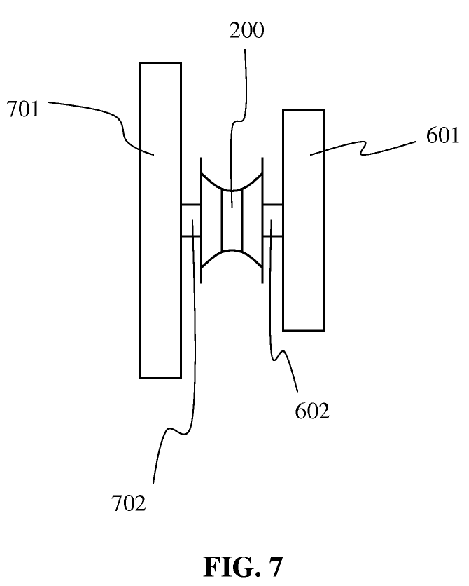

In use, as shown in FIG. 7, the bottom wall 210b of the absorber 200 can be attached to a vehicle support structure 701 via attachment structure 702. The top wall 210a of the absorber 200 can be attached to an interior structure 601, such as a decorative trim piece, air bag cover, escutcheon, or the like via attachment structure 602. In this exemplary configuration, the top wall 210a serves as the impact surface that would receive the immediate force from an impact on the interior structure 601. As described above, the attachment structures 602 and 702 can be in the form of a separate bolt, rivet or similar clamp device, or can be an adhesive or integral clip molded into any of the respective parts (absorber 200, interior structure 601, and/or vehicle support structure 701), or other similar attachment structure or material that is commonly known. The vehicle support structure 701 can be the A-pillar, B-pillar, roof, or other support structure in a vehicle.

The specific shape of the energy absorber 200 can be determined by topology optimization tools in order to optimize the energy absorption efficiency in general, and at varying impact angles and loads. For example, a computer-aided engineering (CAE) tool can be used to provide an initial starting cross-section (e.g., a rough estimate). The CAE could be used to model an energy absorber, an energy absorber support member (e.g., roof member, pillar, etc.) and possibly an impacting member (e.g., passenger or head form). With respect to an initial cross-sectional shape, the CAE could be used to determine a starting height and thickness for the energy absorber sidewalls (which serve as the primary contributor to the stiffness or spring rate). Using a die structure, an initial energy absorber is then extruded and tested. Based on the test results, the die structure is adjusted to modify the initial cross-section (e.g., change the thickness of an energy absorber wall, change radii around corners, etc.) and a subsequent (following) modified energy absorber can be extruded for another round of testing.

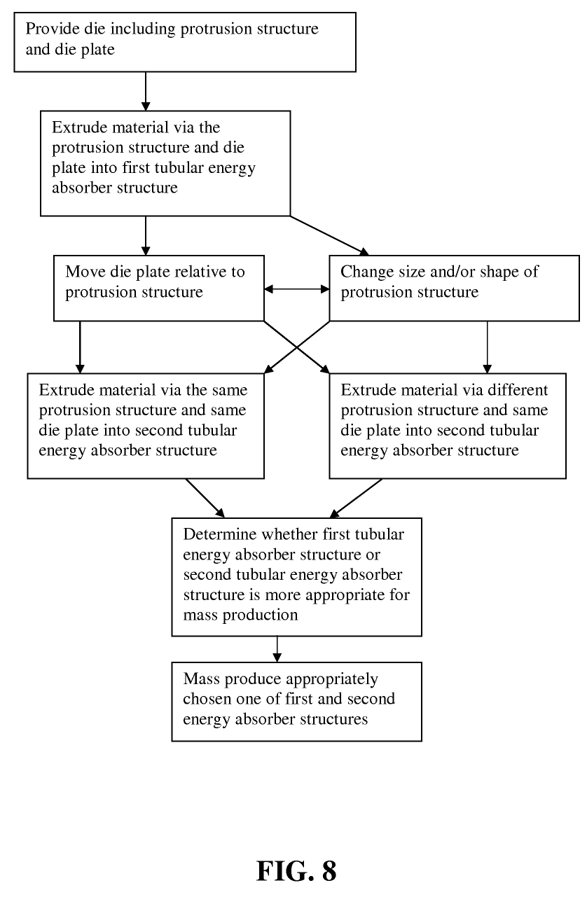

FIG. 8 is a flow chart showing an example of a method for tuning an energy absorber in accordance with the presently disclosed subject matter. The method can include providing a die including a die body, at least one protrusion structure, and at least one die plate. The method includes providing an extrudable material, and using the at least one protrusion structure and the at least one die plate to extrude the extrudable material through the die and into an initial part including a tubular shaped portion.

These same die parts, i.e., the die plate(s) and the protrusion structure(s), are re-used again to produce a second (or following) part including a tubular shaped portion having a different shape. The different shape of the second/following part will provide the second/following part with different energy absorbing characteristics, which can be compared to energy absorbing characteristics of the initial part to determine which part is optimized for a particular application. The different shape can be accomplished by moving at least one of the die plate(s) and/or the protrusion structure(s) relative to the die body, or adjusting the protrusion structure to be of different shape or size.

Finally, the method includes determining which of the extruded parts is optimal for a particular application, and mass producing that optimal part for placement on the vehicle.

It should be noted that the protrusion structure could conceivably be adjusted by including plates thereon that are moved into the exit cavity in the die body to provide a differently shaped/sized protrusion structure relative to the exit cavity. Alternatively, the protrusion structure can have different shapes or sizes along its length, and the appropriate shape or size along the length could be moved to intersect with a plane that defines the exit cavity of the die such that the shape of the extruded material is dictated by that portion of the protrusion structure that intersects with the plane that defines the exit cavity of the die. Of course, a wholly separate protrusion structure can replace an initial protrusion structure located in the die to provide for the different shaped/sized protrusion structure in order to create the differently shaped/sized extruded part.

In accordance with the above-described method, the initial part can have at least a first wall with an initial part first wall thickness t1 and width x, and a second wall with an initial part second wall thickness t2 and height y. The following part can include a tubular shaped portion having at least a first wall with a following part first wall thickness t1 and width x, and a second wall with a following part second wall thickness t2 and height y. The overall shape of the initial part and following part can be a tube or tubes that each have a cross section, when viewed along a longitudinal axis, shaped as a polygonal, oval, circular, symmetrical, non-symmetrical, or other shape. The thickness can refer to a wall thickness of the part, and the width or height can refer to an overall width or height of the entire part. The width and height being interchangeable. For example, an oval can have different wall thicknesses along the periphery of the oval shape, while having a width that is greater than a height of the entire oval structure. Likewise, the “I-beam” structure shown in FIG. 6 includes a complex shape having curved portions and substantially polygonal portions. The height can be measured from the top wall 210a to the bottom wall 210b , while the width can be measured from a mid portion of each side of the side walls 210(c, d). The following part should then be measured at similar locations when comparing shape, and in order to determine the optimal height and width characteristics for the part.

Optimization of energy absorption qualities and configurability of the absorber device 100 for a particular application or vehicle can be accomplished at low cost and with high speed relative to other know methods. In addition, tuning of the device is further facilitated by the fact that common tooling can be used to create differently shaped energy absorbers 100.

From the above discussion, it will be appreciated that many of the problems associated with known energy absorbers are addressed by the teachings of the disclosed subject matter. The energy absorber 100 can be configured to absorb energy from a collision at various impact angles with respect to the energy absorber 100. In addition, the energy absorber may be fabricated relatively easily at a lower cost than existing energy absorbers, and may be used on differently shaped structural members within the same vehicle, or within different types of vehicles. In addition, the tuning of the energy absorber can be accomplished quickly and inexpensively to thus shorten development turn around time and shorten down time if an initially produced energy absorber is found to be deficient. Moreover, prototypes can be quickly and cheaply manufactured to provide a designer multiple samples to choose from in a short time period. Thus, the energy absorber can be better optimized for a vehicle or for a particular application in a short period of time and to a high degree of accuracy.

While the subject matter has been described in detail with reference to exemplary embodiments thereof, it is contemplated that various changes can be made, and equivalents employed. For example, the specific shape of the energy absorber 100 can vary greatly and fall within the scope of the presently disclosed subject matter. Specifically, the cross-sectional shape can be triangular, square, polygonal, circular, oval, non-symmetrical, etc. In addition, the thickness of the walls can vary with respect to each specific separate wall structure as shown in FIG. 4, or the thickness can vary along a surface in the x, y, or z directions. The outer shape of the structure can be different from the inner shape. For example, the energy absorber 100 can have a square outer shape and a circular inner cross-sectional shape. In addition, other structures or materials can be added to the basic energy absorber without departing from the spirit and scope of the disclosed subject matter. For example, the energy absorber 100 can be filled with a foam or other material, can be attached using various structures, can be incorporated into the vehicle as an air duct, conduit, wire harness, etc. All related art references discussed in the above Description of the Related Art section are hereby incorporated by reference in their entirety.

In addition, with respect to the specific die that is used to manufacture the energy absorber 100, the embodiment shown in FIG. 5 is schematic in nature. One skilled in the art of extrusion molding would know many various ways to create a die to accomplish the molding processes described herein. For example, the die can include a single die plate or many different die plates, multiple protrusions, and/or differently shaped plates and protrusions, etc. As described above, the protrusion can also vary along its length and be movable in a lengthwise direction through the die body exit, or can include plates thereon that can be adjusted to cause the shape of the protrusion relative to the die body exit to change.

Furthermore, if multiple protrusions are used, it should be noted that the resulting energy absorber would include an array of tubular structures, and that array could include many similarly shaped tubular structures or can include tubular shapes have varying shapes or sizes. Each of the extruded energy absorbers could be used separately at unique places within a vehicle, or they could be attached to each other via mechanical or adhesive attachment structure to provide a larger energy absorber structure.

While the subject matter has been described in detail with reference to exemplary embodiments thereof, it will be apparent to one skilled in the art that various changes can be made, and equivalents employed, without departing from the scope of the invention. All related art references discussed in the above Description of the Related Art section are hereby incorporated by reference in their entirety.

What is claimed is:

1. A method for tuning an energy absorber for use on a vehicle, comprising:
providing a die including at least one protrusion structure and at least one die plate;
providing an extrudable material;
using the at least one protrusion structure and the at least one die plate to extrude the extrudable material into an initial part including a tubular shaped portion, the initial part having at least a first wall portion with an initial part first wall thickness t1 and width x, and a second wall portion with an initial part second wall thickness t2 and height y;
re-using only previously used ones of the at least one protrusion structure and previously used ones of the at least one die plate to extrude the extrudable material into a following part including a tubular shaped portion, the following part having at least a first wall portion with a following part first wall thickness t1 and width x, and a second wall portion with a following part second wall thickness t2 and height y;
determining at least one of an optimum thickness for t1 and optimum width for x by comparing at least one of the initial part first wall thickness t1 and width x with a corresponding one of the following part first wall thickness t1 and width x; and
producing an energy absorber having a first wall portion having at least one of the optimum thickness t1 and optimum width x.

2. The method of claim 1, further comprising:
determining at least one of an optimum thickness for t2 and optimum height for y by comparing a corresponding one of the initial part second wall thickness t2 and height y with a corresponding one of the following part second wall thickness t2 and height y; and
producing an energy absorber having a second wall portion having at least one of the optimum thickness t2 and optimum height y.

3. The method of claim 1, wherein the extrudable material is a plastic material.

4. The method of claim 1, wherein re-using includes moving at least one of the at least one protrusion structure and the at least one die plate and then extruding the extrudable material through the die.

5. The method of claim 1 wherein the energy absorber has a rectangular cross section as viewed along a longitudinal axis of the energy absorber.

6. A method for making an energy absorber for a vehicle, comprising:
using a set of die parts to extrude a first energy absorber having a first wall, and the first wall having a first thickness and first width;
using the same set of die parts to extrude a second energy absorber having a first wall, and the first wall of the second energy absorber has a second thickness and a second width, and at least one of the second thickness and second width is different from a respective one of the first thickness and first width of the first energy absorber;
determining whether to mass produce the first energy absorber or the second energy absorber; and
mass producing at least one of the first energy absorber and the second energy absorber.

7. The method of claim 6, wherein determining includes determining an optimal thickness and width for the first wall, and mass producing includes mass producing an energy absorber that has a first wall with the optimal thickness and width.

8. The method of claim 6, wherein the first energy absorber and the second energy absorber are rectangular in cross section when viewed along a longitudinal axis of a respective one of the first energy absorber and second energy absorber.

9. The method of claim 6, wherein the first energy absorber includes a second wall, and the second wall has a thickness and a width, and
the second energy absorber includes a second wall, and the second wall of the second energy absorber has a thickness and a width, and
at least one of the thickness and width of the second wall of the second energy absorber is different from a respective one of the thickness and width of the second wall of the first energy absorber.

10. The method of claim 6, wherein the set of die parts consists essentially of a die body, at least one protrusion structure, and at least one die plate.

11. A method for tuning an energy absorber for use on a vehicle, comprising:
providing a die including a die body, at least one die plate, and at least one protrusion structure;
providing an extrudable material;
using the die to extrude the extrudable material into an initial part including a tubular shaped portion, the initial part having an initial cross section shape as viewed along a longitudinal axis of the initial part, at least a first wall of the cross section shape having an initial part first wall thickness t1 and width x;
adjusting at least one of the at least one die plate and the at least one protrusion structure such that a positional relationship between the die body and at least one of the at least one die plate and the at least one protrusion structure is changed, and then using the die to extrude the extrudable material into a following part including a tubular shaped portion having a substantially similar cross-section shape, the following part having a following part first wall thickness t1 and width x;
determining at least one of an optimum thickness for t1 and optimum width for x by comparing a corresponding one of the initial part first wall thickness t1 and width x with a corresponding one of the following part first wall thickness t1 and width x; and
producing an energy absorber having a substantially similar cross section shape and a first wall having at least one of the optimum thickness t1 and optimum width x.

12. The method of claim 11, wherein the extrudable material is a plastic material.

13. The method of claim 11, wherein adjusting includes moving the at least one die plate relative to the die body.

14. The method of claim 11, wherein adjusting includes moving the at least one protrusion structure relative to the die body.
